(19) United States
(12) Patent Application Publication
(10) Pub. No.: US 2007/0027730 A1
(43) Pub. Date: Feb. 1, 2007

(54) System and method for online collective decision making

(76) Inventor: James M. McArdle, Austin, TX (US)

Correspondence Address: IBM CORPORATION (SWP), C/O SUITER SWANTZ PC LLO, 14301 FNB PARKWAY, SUITE 220, OMAHA, NE, 68154-5299, US

(21) Appl. No.: 11/189,885

(22) Filed: Jul. 26, 2005

(51) Int. Cl. G06F 9/44; G06F 17/50

(52) U.S. Cl. 705/7

(57) ABSTRACT

The present invention is directed to a system and method for online collective decision making without wasting resources through peer-policing based on administrative rules. Online collective decision administrative rules may be provided to a web application server. The administrative rules may have several thresholds and conditions in order to determine when an online collective decision is terminated. Each responder on a communication network may submit a response including an inappropriate content user selection, or a desired answer through an online collective decision form presented by the web application server. Upon reception of the response, several counts may be updated to be compared against several thresholds set forth by the administrative rules. When one of the counts exceeds a threshold set forth by the administrative rules, the online collective decision process may be terminated. Each responder may be notified of the termination, a reason for termination, and the results of the online collective decision process.

### FIELD OF THE INVENTION

The present invention generally relates to the field of group collaboration, and particularly to a system and method for making an online collective decision without wasting resources through enforcing administrative rules.

### BACKGROUND OF THE INVENTION

As the Internet continues to revolutionize the way people communicate, the computer is gradually replacing the telephone as the most efficient vehicle for collective decisions such as a survey, a poll and the like. A web application server has been used to process individual choices or votes into collective outcomes in surveys, polls and other collective decisions. For example, the web application server allows a user to create an online poll for a group of users. The group of users may vote for the poll to participate in the online polling process through the web application server. Voting statistics may be available to the group of users throughout the online polling process. However, the online polling process occupies network bandwidth as each responder user is getting updates, which may slow down other operations in the web application server.

Certain online poll (survey) content may be inappropriate for a particular group of users. For example, company A provides a web application server for its employees to have a fast collective decision through an online polling. If one employee creates an online poll with content upsetting other employees, such online poll is inappropriate and needs to be terminated. A human administrator may monitor the content of each online poll created and terminate an online poll when it has been determined that the content of the online poll is inappropriate. However, this is very time consuming and costly. Further, it may be challenged for being unfair or undemocratic. Even if the human administrators feel that the content is inappropriate, a majority of the users may feel that the content is appropriate.

Therefore, it would be desirable to provide a system and method for providing an online collective decision making process without wasting resources such as network bandwidth. It would be also desirable to provide a system and method for providing an objective policing feature to prevent inappropriate content from being posted for the online collective decision.

### SUMMARY OF THE INVENTION

Accordingly, the present invention provides a system and method for an online collective decision without wasting resources through enforcing administrative rules. The system and method may provide an objective policing feature such as peer-policing by each responder.

In an exemplary aspect of the present invention, a method for an online collective decision making process is provided. Online collective decision administrative rules may be provided to a web application server. The administrative rules may have several thresholds and conditions in order to determine when to terminate the online collective decision making process. The web application server may receive a question for the online collective decision and possible answers for the question from a creator user. The online collective decision form may be created, including the question, the possible answers and a user selection to indicate inappropriate content (an inappropriate content user selection). The online collective decision form may be presented to a group of responders. Each responder may submit a response including the inappropriate content user selection, or a desired answer through a web based user interface.

Upon reception of the response from a responder, several counts may be updated to be compared against several thresholds set forth by the administrative rules. For example, an inappropriate content count and a total responder count may be updated upon reception of the inappropriate content user selection. The responder count and a corresponding count for the desired answer may be updated upon reception of the desired answer. When one of the counts exceeds a threshold set forth by the administrative rules, the online collective decision making process may be terminated. Each responder may be notified of the termination, the reason for termination, and the results of the online collective decision making process.

In an additional aspect of the present invention, a system for online collective decision making includes a web application server for allowing responders to participate in an online collective decision for a question provided by a first user. A database may be coupled to the web application server, including a template of a Graphic User Interface for providing the question and a plurality of answers in the online collective decision, a result of the question, and administration rules. The web application server may be communicatively coupled to an administration module for enforcing the administration rules. The administration module terminates the online collective decision making process when a certain condition of administration rules is met. The administration module displays a notification message upon termination of the online collective decision making process.

In another additional aspect of the present invention, an objective policing feature for an online collective decision making process is provided. Peer-policing by each responder in the group may be implemented to prevent inappropriate content from being posted for the online collective decision. Each responder may be allowed to submit his or her desired answer for the question or the inappropriate content user selection to indicate inappropriate content of the question. The online collective decision making process may be terminated when a certain number of responders submit the inappropriate content user selection. As such, each responder may be able to police the online collective decision making process and determine whether it is to be terminated in a democratic way.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a block diagram of an environment for an online collective decision system in accordance with an exemplary embodiment of the present invention;

FIG. 2 is a flow diagram of a method for making an online collective decision in accordance with an exemplary embodiment of the present invention;

FIG. 3 is an exemplary Graphic User Interface (GUI) to receive a question for an online collective decision system in accordance with an exemplary embodiment of the present invention;

FIG. 4 is an exemplary GUI to present the question for an online collective decision to several responders in accordance with an exemplary embodiment of the present invention;

FIG. 5 is a screen to display results of the question presented in FIG. 4 in accordance with an exemplary embodiment of the present invention; and

FIG. 6 is a screen to display results of the question presented in FIG. 4 in accordance with an additional exemplary embodiment of the present invention.

### DETAILED DESCRIPTION OF THE INVENTION

Reference will now be made in detail to the presently preferred embodiments of the invention, examples of which are illustrated in the accompanying drawings.

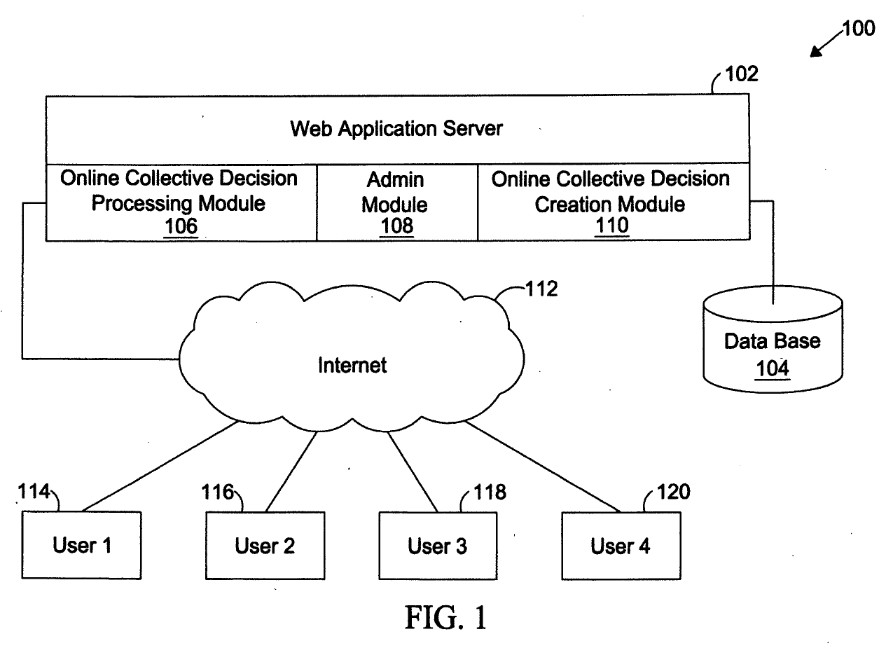

Referring now to FIG. 1, a block diagram of an online collective decision system 100 in accordance with an exemplary embodiment of the present invention is shown. The online collective decision system 100 may include a web application server 102 for allowing a group of users (responders) 114-120 on a communication network (such as the Internet, a wired and/or wireless local network, and the like) 112 to participate in an online collective decision making process. The web application server may include Admin Module 108 configured to enforce administrative rules. Admin Module 108 may terminate the online collective decision making process when a certain condition set forth by the administrative rules is met. Admin Module 108 displays a notification message upon termination of the online collective decision making process. In an alternative embodiment, Admin Module 108 may be a separate module from the web application server 102, communicatively coupled to the web application server 102. A database 104 may be coupled to the web application server 102. The administration rules may be stored in the database 104.

In a particular embodiment of the present invention, the web application server may include Online Collective Decision Processing Module (OCDPM) 106 and Online Collective Decision Creation Module (OCDCM) 110. OCDCM 110 may be configured to receive a question to be asked for an online collective decision from a first user (a creator user). The first user may be one from the group of users (responders) 114-120. In an alternative embodiment, OCDCM 110 may verify whether the creator user has an authority to initiate the online collective decision. For example, the creator user may be asked to enter a login name and a password before submitting a question for an online collective decision.

OCDCM 110 may be configured to receive possible answers (responses) to be posted for the question from the creator user. Alternatively, OCDCM 110 may ask the creator user to utilize a template for creating an online collective decision form. The template may include a polling template, a survey template, and the like. OCDCM 110 may create the online collective decision form including the question, the possible answers, information regarding the creator user, an inappropriate content user selection, and the like. Each responder may submit the inappropriate content user selection to indicate that the content of the online collective decision is not appropriate. The created form may be stored in the database 104. In an embodiment, the online collective decision form may be presented to the several users via a web based GUI for receiving responses from the group of users.

OCDPM 106 in conjunction with Admin Module 108 may collect responses from the several users. Upon reception of a response, OCDPM 106 may update several counts, a result of the question, and the like for the online collective decision form. Examples of the counts include a count of total responders, a count of inappropriate content, a count of one of possible answers and the like. Then, Admin Module 108 may monitor whether a certain condition of administrative rules is met. The administrative rules may include a threshold for each of the several counts.

It is contemplated that the administrative rules may include various conditions for formulating an online collective decision among a certain group. The administrative rules may include a time period for a group of users to view the results of the online survey, the maximum number of total responders allowed to vote, a time period for a life of the online collective decision making process, and the like. Further, the administrator may be given authority to control the process of the online collective decision making by overwriting the administrative rules. For example, an online collective decision having an important question may not be a subject of termination even if certain percentages of responders who submit that the content is inappropriate are over the threshold.

When any of the counts is over its corresponding threshold, Admin Module 108 may ask OCDPM 106 to stop receiving responses whereby the online decision making process is terminated. Then, Admin Module 108 may display a notification message explaining the reason why the online collective decision making process is terminated.

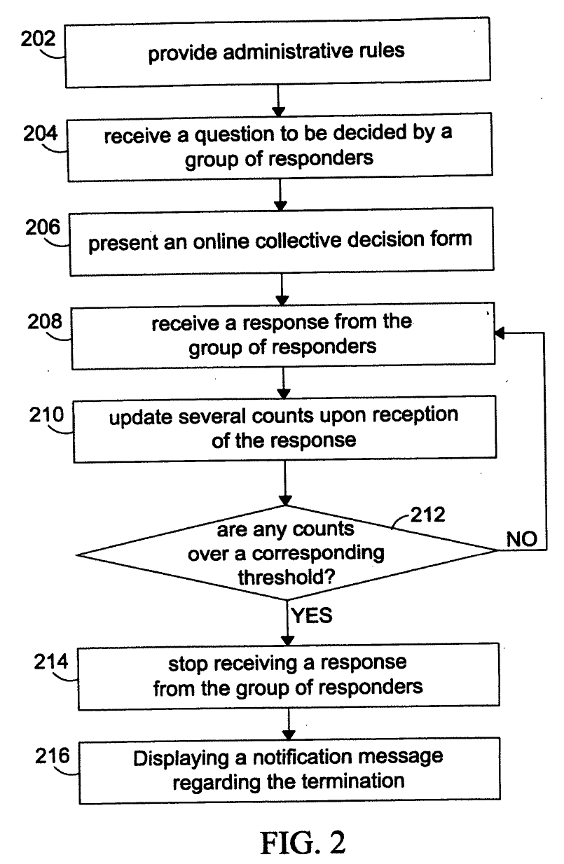

Referring now to FIG. 2, a flow diagram of a method 200 for making an online collective decision in accordance with an exemplary embodiment of the present invention is shown. In step 202, online collective decision administrative rules may be provided to a web application server. The administrative rules may have several thresholds and conditions in order to determine when a certain online collective decision is made or subject to be terminated. In step 204, the web application server may receive a question for the online collective decision and possible answers for the question from the creator user. The online collective decision form including the question, the possible answers and the inappropriate content user selection may be presented to responders in step 206. It is contemplated that the online collective decision form may be a web based GUI suitable for receiving responses from a group of responders on the communication network. However, one of ordinary skill in the art will appreciate that there are various ways to receive responses from the group of responders on the communication network.

In step 208, each responder may submit a response including the inappropriate content user selection or a desired answer through the online collective decision form. Upon reception of the response, several counts may be updated to be compared against several thresholds set forth by the administrative rules in step 210. For example, an inappropriate content count and a responder count may be updated upon reception of the inappropriate content user selection. The responder count and a corresponding count for the desired answer may be updated upon reception of the desired answer. Whether one of the counts exceeds a corresponding threshold set forth by the administrative rules may be determined in step 212. If one of the counts exceeds its corresponding threshold, the online collective decision process may be terminated in step 214. Each responder may be notified of the termination, a reason of the termination, and the results of the online collective decision process in step 216. If one of the counts does not exceed its corresponding threshold, a response submitted by one responder may be received in step 208 and then several counts may be updated to be compared against several thresholds set forth by the administrative rules in step 210 until one of the counts exceeds its corresponding threshold.

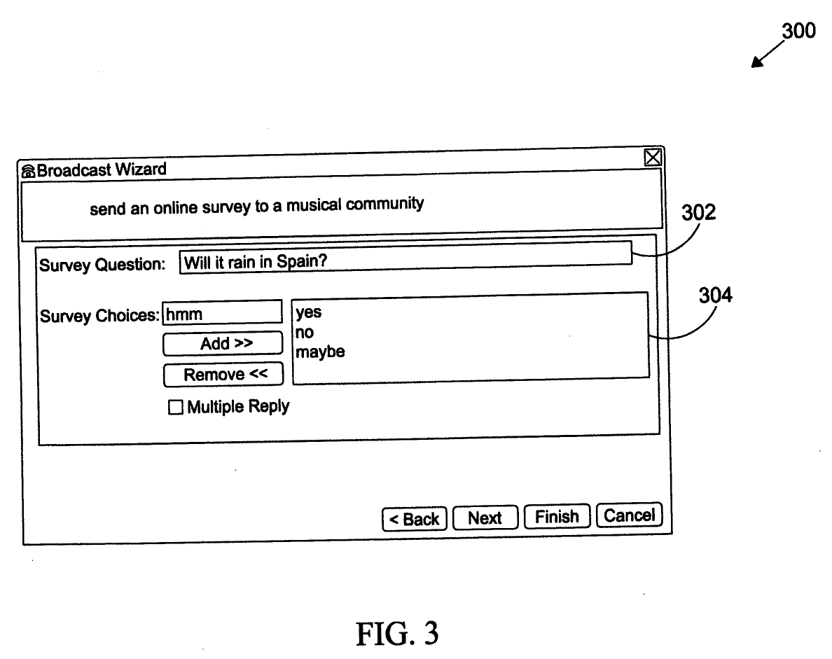

In FIG. 3, an exemplary Graphic User Interface (GUI) 300 suitable for receiving a question to be asked for an online collective decision is shown. In an embodiment of the present invention, a user may be allowed to set up an online survey through the GUI 300. As discussed above, the online collective decision may include an online survey, an online poll, and the like. The user may submit a question to be asked, for example, “Will it rain in Spain?” in Survey Question 302. The user may enter each of possible answers for the question in Survey Choices 304. Once complete, the user may submit the online survey form to the web application server to present the question to a group of responders. In an alternative embodiment, the user may specify a desirable group of responders who are suitable for participating in the online survey.

For example, the user may specify a community (a group of users having the same interest) to ask “Will it rain in Spain?” which is a quote from the musical “My Fair Lady” based on Bernard Shaw's Pygmalion.

Then, the user may enter possible answers such as “YES”, “NO”, “MAYBE”, and the like. Upon completion, the user may select “Finish” button to submit the online survey form to the web application server.

In an embodiment of the present invention, each user of the group specified by the first user may have a notification that the online survey has been started. Examples of the notification include a message box, an icon indicating the notification, and the like. When a user of the group decides to vote on the online survey, a GUI suitable for receiving a response may be displayed to present the question and possible answers of the online survey.

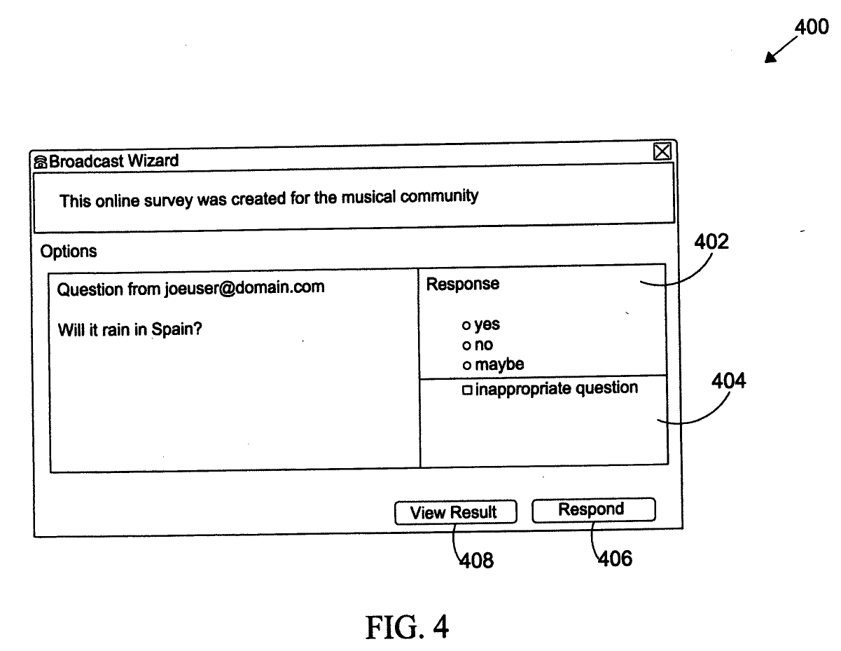

Referring to FIG. 4, an exemplary GUI 400 to present the question for the online survey is shown. The GUI 400 may include the question to be surveyed, a menu choice 402 of the possible answers, and an inappropriate content user selection 404 to indicate inappropriate content (e.g. an inappropriate question). For example, the question “Will it rain in Spain?” may be inappropriate for a community having no interest in musicals or Bernard Shaw. When the user thinks the content (question) of the survey is inappropriate, the user may select the inappropriate content user selection 404 and submit the response by pressing “Respond” button 406. The user may have a choice of viewing a result of the online survey and submitting a response to participate in the online survey by selecting “View Result” button 408 and “Respond” button 406.

In an embodiment of the present invention, one user may be allowed to submit one response for one online collective decision form. In this manner, peer-policing may be implemented in a democratic way. In another embodiment, each user may have a weight based on a role in the group, the community or the like. For example, a manager of the creator user may have an authority to terminate the online survey if the manager finds the content is inappropriate for the group. An administrator of the online collective decision system may have an authority to terminate the online survey if the administrator finds the content is inappropriate for the general public.

The administrative rules may include several thresholds for the online survey. The first threshold may be if certain percentage of group submits that the content of survey is inappropriate. The administrative rules may have minimum total participants for termination. If the first threshold is 10% and the minimum total participants is 1000, the survey may be stopped at 100 participants select the inappropriate content user selection 404. It is contemplated that the administrative rules may include various conditions for formulating an online collective decision among a certain group. The administrative rules may include a time period for a group of users to view the result of the online survey, a maximum number of total participants allowed to vote, a time period for the life of the online survey, and the like. Further, the administrator may be given an authority to control the process of the online collective decision making by overwriting the administrative rules. For example, an online collective decision having an important question may not be a subject to be terminated even if threshold percentages of responders submit that the content is inappropriate.

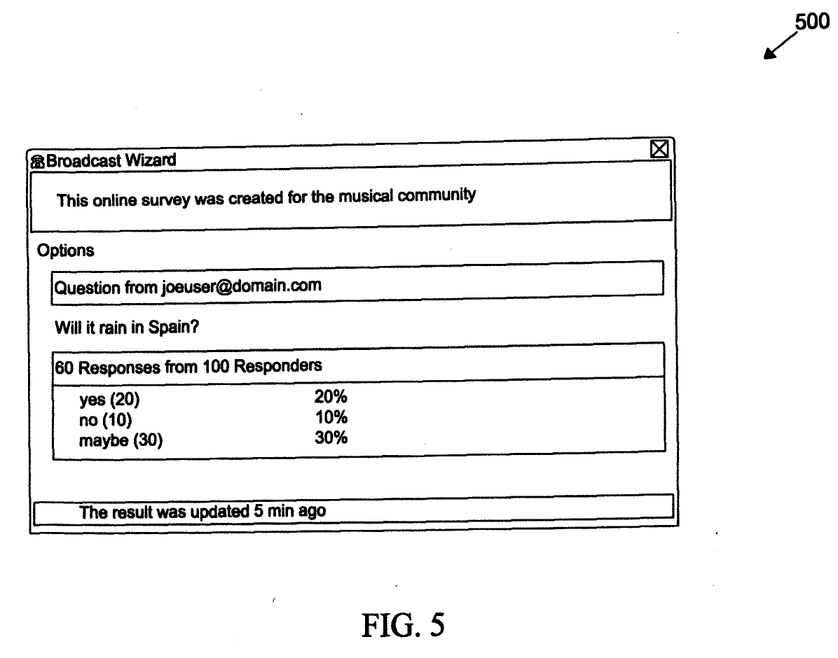

In FIG. 5, a screen 500 to display the results of the question presented in FIG. 4 is shown. In an embodiment of the present invention, a result screen 500 may be displayed when a user requests to view the result of the online survey. The result screen 500 may include the question, information of the creator user, a number of votes for each possible answer, and a number of votes for inappropriate content. If the administrative rules have a predetermined time period for viewing the result, the result screen 500 will be refreshed after the predetermined time period. In this manner, the online collective decision making process may be prevented from occupying network bandwidth due to frequent updates of the results.

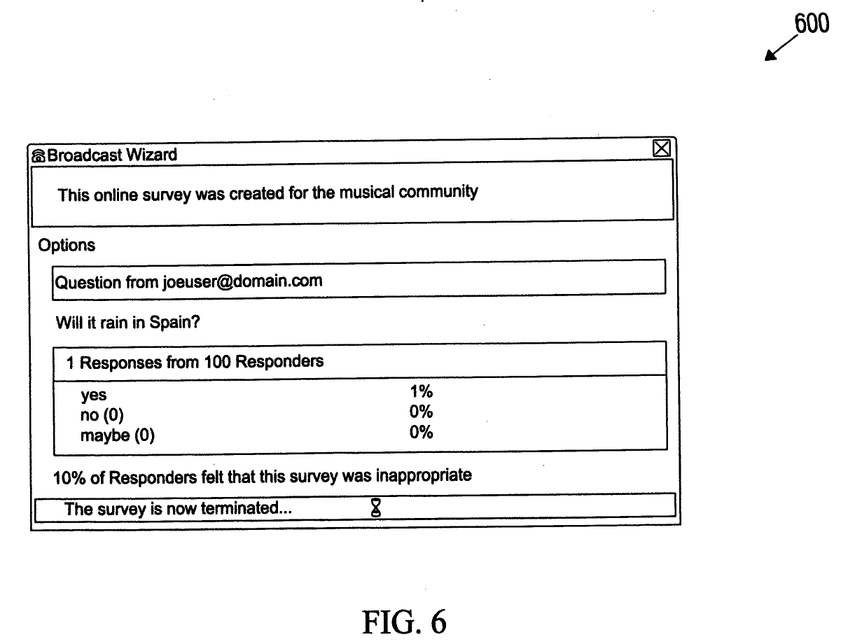

In FIG. 6, a screen to display the results of the question and a reason for termination of the online collective decision is shown. In an embodiment of the present invention, when the system terminates the online collective survey, a notification may be displayed for each of responders including the creator user. The notification may include the reason of the termination, a result of the online survey, number of participants, an administrative rule applied for termination, and the like.

It is to be noted that the foregoing described embodiments according to the present invention may be conveniently implemented using conventional general purpose digital computers programmed according to the teachings of the present specification, as will be apparent to those skilled in the computer art. Appropriate software coding may readily be prepared by skilled programmers based on the teachings of the present disclosure, as will be apparent to those skilled in the software art. It is to be understood that the present invention may be conveniently implemented in forms of a software package. Such a software package may be a computer program product which employs a computer-readable storage medium including stored computer code which is used to program a computer to perform the disclosed function and process of the present invention. The computer-readable medium may include, but is not limited to, any type of conventional floppy disk, optical disk, CD-ROM, magneto-optical disk, ROM, RAM, EPROM, EEPROM, magnetic or optical card, or any other suitable media for storing electronic instructions.

It is understood that the specific order or hierarchy of steps in the methods disclosed are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for making an online collective decision, comprising:
receiving a question for the online collective decision and possible answers for the question;
presenting an online collective decision form to a plurality of responders, the online collective decision form including the question, the possible answers and an inappropriate content user selection;
receiving a response from the plurality of responders through the online collective decision form, the response including one of the inappropriate content user selection and a desired answer of the possible answers;
terminating the online collective decision by stopping receiving responses from the plurality of responders based on administrative rules provided; and
displaying a result of the online collective decision to the plurality of responders.

2. The method as described in claim 1, further comprising:
updating a first count and a second count upon reception of the inappropriate content user selection; and
updating the second count and a third count upon reception of the desired answer, wherein the first count reflects a number of respondents indicating the question is inappropriate, the second count reflects a total number of responders participating in the online collective decision, and the third count reflects a number of responders voting for one of the possible answers.

3. The method as described in claim 1, wherein the online collective decision form is a web based Graphic User Interface.

4. The method as described in claim 2, wherein the online collective decision is terminated when a ratio between the first count and the second count is over a first threshold being included in the administrative rules.

5. The method as described in claim 2, wherein the online collective decision is terminated when a ratio between the third count and the second count is over a second threshold being included in the administrative rules.

6. The method as described in claim 2, wherein the administrative rules include a weight for each of the plurality of responders and the first count is calculated based on the weight for each of the plurality of responders.

7. The method as described in claim 1, further comprising
displaying a notification message after termination of the online collective decision, wherein the notification message includes a reason for termination.

8. The method as described in claim 1, wherein the result of the online collective decision is displayed after a time period, the time period being included in the administrative rules.

9. A system for online collective decision making, comprising:
a server for allowing responders to participate in an online collective decision through a Graphic User Interface;
a database, coupled to the server, including a template of the Graphic User Interface for providing a question and a plurality of answers provided by a first user, a result of the question, and administrative rules; and
an administration module, communicatively coupled to the server for enforcing the administration rules by terminating the online collective decision and displaying a notification message upon termination,
wherein the template of the Graphic User Interface is associated with a list of counts including an inappropriate content count, an responder count, and a corresponding count for each of the plurality of answers.

10. The system as described in claim 9, wherein the thresholds in the administrative rules include a first threshold and the online collective decision is terminated when the ratio of the inappropriate content count and the responder count is over the first threshold.

11. The system as described in claim 9, wherein the thresholds in the administrative rules include a second threshold and the online collective decision is terminated when the ratio between the corresponding answer count and the responder count is over the second threshold.

12. The method as described in claim 9, wherein the administrative rules include a weight for each responder and the inappropriate content count is updated differently based on the weight for each responder.

13. The method as described in claim 9, further comprising,
displaying an updated result of the question asked in the online collective decision only after a predetermined time period.

14. A computer-readable medium having computer-executable instructions for
performing a method for online polling, the method comprising:
providing administrative rules including termination conditions, a time period, and several thresholds;
receiving user information of a first user, a question for a desired online poll and possible answers for the question;
storing the user information of the first user, the question, and the possible answers into a database;
providing an online polling form including the question, the possible answers and a user selection to indicate inappropriate content, the online polling form being a web based Graphic User Interface;
receiving a response from a second user through the online polling form, the response including one of an appropriate content selection and a desired answer of the possible answers;
updating a plurality of counts upon reception of the response, the plurality of counters including an inappropriate content count, a total responder count, and a corresponding count for each of the plurality of answers;
terminating the online polling form if one of the termination conditions is met; and
notifying the first user and the second user upon termination of the online polling,
wherein the first user and the second user are a plurality of responders on a communication network and the termination condition and the time period are included in the administrative rules.

15. The computer-readable medium as described in claim 14, wherein the online polling from is terminated when a ratio between the corresponding count of one of the plurality of answers and the responder count is over a first threshold.

16. The computer-readable medium as described in claim 14, wherein the online polling form is terminated when the ratio of the inappropriate content count and the responder count is over a second threshold.

17. The computer-readable medium as described in claim 14, wherein the online polling form is terminated when a responder with higher authority than the first user selects the appropriate content selection.

18. The computer-readable medium as described in claim 14, wherein the responder with authority includes a manager of the first user.

19. The computer-readable medium as described in claim 14, wherein the method further comprises displaying a result of the online polling collected during the time period.
